(19) United States
(12) Patent Application Publication
(10) Pub. No.: US 2017/0123412 A1
(43) Pub. Date: May 4, 2017

(54) MODEL AIRPLANE

(71) Applicants: Yu Tian, Jinxi City (CN); Wenyan Jiang, Jinxi City (CN)

(72) Inventors: Yu Tian, Jinxi City (CN); Wenyan Jiang, Jinxi City (CN)

(21) Appl. No.: 14/929,553

(22) Filed: Nov. 2, 2015

(51) Int. Cl. G05D 1/00; G05D 1/08; G05D 1/04; G05D 1/10; B64C 39/02; G05D 1/06

(52) U.S. Cl. CPC G05D 1/0011; B64C 39/024; G05D 1/0607; G05D 1/042; G05D 1/101; G05D 1/0833; B64C 2201/146

(57) ABSTRACT

The invention involves in a control system for a model airplane, in particular, a kind of model airplane whose flight posture can be automatically controlled in real time according to the flight data determined through detection devices and air pressure sensors.

### FIELD OF THE INVENTION

The technical field of the invention relates to remote and on-board control of a model airplane, in particular, a kind of model airplane whose flight posture can be automatically controlled wirelessly by a remote user.

### BACKGROUND OF THE INVENTION

With the popularity and promotion of model airplane movement, there are more and more amateurs purchasing and flying remote-control model airplanes in recent years, whose control of existing model airplanes basically is not automatically controlled, i.e., by automatic attenuating, enhancing, blocking, or substituting inputs of a user to a wireless remote control device. Therefore, if beginners practice flight, the plane is very likely to fall to ground, endanger others, or become damaged due to improper control when such beginners are controlling the takeoff and landing of the planes, or in their approach patterns to landing or from take-off. In this way, flying practice of beginners will be heavily affected, so that beginners believe that it is difficult to get started, and further popularity of the model airplane movement among the public is also affected. There is a need for a system incorporating digital modification of a beginner's user input (or lack thereof) into wireless remote control device.

### SUMMARY OF THE INVENTION

The invention involves in a control system for a model airplane, in particular, a kind of model airplane whose flight posture can be automatically controlled in real time according to the flight data determined through detection devices and air pressure sensors.

The technical problem that the invention needs to solve is to overcome the defect that model airplanes have no automatic control function in existing technology, and result in the easy damage of model airplanes on account of improper control by beginners, thereby provide the model airplanes whose flight postures can be automatically controlled by the flight data determined through detection device and air pressure sensors in real time.

The invention solves the above technical problems through the following technical solutions:

A model airplane provided by the invention is characterized in that it includes an air pressure sensor and a control device of air pressure for the model airplane in a real-time detection. The pressure sensor is used to transmit a signal indicating ambient air pressure at the model airplane, preferably from a relatively quiescent location substantially unaffected by air flow around the model airplane. The air pressure signal is received to a control device secured to the model airplane, where the control device comprises input/output circuits (including ND and D/A elements for respectively receiving and transmitting analog signals) for a microprocessor comprising memory, the combination operating under a control program, all powered by a battery on-board the model airplane.

A flight air pressure signal sensed when the model plant is in flight is transmitted from the pressure sensor to the control device, where the value of the sensed air pressure is used in the control program to calculate a flight altitude of the model airplane. In a preferred embodiment, an air pressure signal is detected before take-off, wherein the control device assigns to the ground air pressure value an altitude value of zero for the ground level sensed air pressure. Preferably, the ground air pressure value and its zero altitude association are used by the control program in combination with the flight air pressure signal to calculate a current altitude of the model airplane nearly instantly. The calculated altitude of the model airplane is optionally stored in the memory of the microprocessor.

A pre-determined control altitude value is stored in the memory of the microprocessor. If a calculated altitude is greater than the controlled altitude value, the control program takes no action to attenuate, enhance, block, or substitute inputs of a user to a wireless remote control device transmitted to the model airplane to assist the user in flying the model airplane.

However, if a calculated altitude is equal to or less than the controlled altitude value, the control program operates by way of a protection mode to attenuate, enhance, block, or substitute inputs of a user to a wireless remote control device transmitted to the model airplane to assist the user in flying the model airplane. The intent of the protection mode is to prevent an inexperienced user from implementing control inputs to the model airplane that are highly likely to cause the model airplane to become unstable or crash. In this way, an inexperienced user is protected by inadvertently causing the model airplane to crash during taking off and landing steps.

In other words, the calculated altitude value is compared with a pre-determined altitude value that may result in the model airplane entering a protection mode while the flight altitude is detected smaller or equal to the pre-determined control altitude value. The purpose of the protection mode is to control the flight posture of the model airplane and make it keep flying.

Air pressure of model airplane can be detected in real time by utilizing pressure sensor, thus the control device is able to calculate flight altitude of model airplane on the basis of air pressure, specifically through comparing the current air pressure detected by air pressure sensor with the air pressure when the model airplane exactly takeoff to calculate relative flight altitude of the model airplane.

Then, the flight altitude is detected by the control device which sends control signal to the model airplane according to the different flight altitude as well as the user's control conditions, so as to automatically control the model airplane entering into protection mode and control the flight posture of the model airplane in real time in order to make it keep flying. The flight altitude includes ascent, descent and swerve of the flight altitude, which is the general knowledge in this field, so it won't be repeated here. The flight altitude enables the model airplane to refuse to perform the operations in external remote signals that may cause accidents of the model airplane, to prevent the model airplane from crashing and guarantee the flight safety of the model airplane.

The detailed functions of the microprocessor and memory of the control device can be served by a single computer chip, which may also include prior art inputs of flight control commands from a wireless user controller and outputs to engines, propellers, flaps and other control features of a model airplane or drone.

It is preferred that the a first condition of the protection mode is used to help keep a model airplane flying by moderating inputs of a wireless remote controller when the flight altitude calculated by the control device is smaller than or equal to a first predetermined control altitude through detection of ambient air pressure at the model airplane.

When the flight altitude of the control device is larger than the first control altitude, and smaller than a second predetermined control altitude threshold, a second condition of the protection mode is optionally used to keep the model airplane flying by moderating inputs of a wireless remote controller.

When the flight altitude of the control device is larger than the second altitude threshold, a third condition of the protection mode optionally is used to keep the model airplane flying by moderating inputs of a wireless remote controller.

The restrictions on ranges of inputs from the wireless remote controller permitted to be implemented without moderation by the control device are relaxed sequentially as the altitude of the model airplane rises past the first control altitude, the second control altitude, and the third control altitude, i.e., automatic control of the model airplane by the control device weakens successively from the first condition, the second condition to the third condition.

In a specific example, when the flight altitude of the control device is smaller than or equal to the first altitude threshold through detection, the first condition of the protection mode is preferably restricts a pitch angle of the entire model airplane larger than or equal to 0 degrees, a roll angle is restricted to between −20 degrees to +20 degrees, and the a descent speed is restricted to be less than or equal to 1 m/s, regardless of inputs of a user to the wireless remote controller. That is, in more general terms, the above first condition restricts inputs of a user of the wireless remote controller to keep the model airplane flying at the lowest of flight altitudes.

Therefore, when the flight altitude is low (i.e. smaller than or equal to the first control altitude threshold), there shall be strictest control on the model airplane, and the manual control freedom degree of users will be at its most restrictive. Causing the model airplane to maintain a pitch angle larger than or equal to 0 degrees, that is, causing the model airplane to ascend or maintain horizontal flight without descent, can avoid plane crash resulting from amateur users forcing the model airplane descend with wireless remote controller at a steep pitch angle. The largest value of the pitch angle is the value under the circumstance that the model airplane can fly normally, which is well known in the general knowledge in this field. The control device operating in the model airplane can achieve the above control procedures through controlling the angular acceleration and gravity acceleration of the model airplane.

In another specific example, when the flight altitude of the control device is higher than the first control altitude threshold and smaller than or equal to the second control altitude threshold, a second condition of the protection mode is used to cause the pitch angle of the entire model airplane be restricted to positively greater than or equal to −10 degrees, the roll angle value is caused to be restricted to between −45 degrees to +45 degrees, and the descent speed is restricted by the control device to be less than or equal to 3 m/s.

When the flight altitude of the model airplane is larger than the first control altitude threshold, and smaller than or equal to the second altitude threshold, then users are allowed to control the flight altitude of the model airplane through remote control and make the plane descend, but there are limitations on the descent angle and descent speed values.

When the flight altitude of the control device is greater than the second control altitude threshold, a third condition of the protection mode is used to restrict the pitch angle of the model airplane to be greater than or equal to −30 degrees, and the altitude value be larger than the second altitude threshold. That is, the above keeps the model airplane safely flying at a second range of flight altitudes by way of the restrictions of the second condition.

When the flight altitude of the model airplane is higher than the second altitude threshold, the control freedom degree of the flight posture of the model airplane by users will be largely increased, and the users are optionally allowed to freely control the descent angle and descent speed of the model airplane in relevant larger value scope in the third condition of the protection mode through remote control. That is, the above keeps the model airplane safely flying at a second range of flight altitudes by way of the restrictions of the third condition.

Notwithstanding the above specific examples, the predetermined and stored restriction range values of for pitch angle and roll angle for the protection mode can be changed in the control device memory by input from a user interface of the wireless remote controller or other wireless communication device. As an amateur user becomes more proficient, the ranges of the various conditions of the protection mode can be expanded, optionally by the user.

It is well known that the model airplane comprises a fuselage, wings and some form of stabilizer structure, such as a tail. Flight control means comprise flaps for flight control and structure of engine speed control and are generally controlled by signals from the control device by way of signals received from the wireless remote controller.

It is preferred that in the first condition, the control device makes the descent speed of the model airplane be smaller than or equal to the first speed value.

In the second condition, the control device makes the descent speed of the model airplane be smaller than or equal to the second speed value.

The second speed value is larger than the first speed value.

It is preferred that the first altitude threshold is 10 m, and the second altitude threshold is 30 m.

It is preferred that the control device comprises a detection device operatively connected with the processing device that comprises the microprocessor and memory. The detection device comprises an acceleration sensor that detects a three-axis angle of angular acceleration of the model airplane and outputs to the microprocessor an acceleration signal incorporating the detected angular accelerations. The detection device also comprises a gravity sensor that detects a three-axis angle of gravity acceleration of the model airplane and outputs to the microprocessor a gravity signal incorporating the detected gravity accelerations. The detection device senses and transmits these acceleration values to the processing device periodically, preferably at intervals of 0.01 to 1.0 seconds. The processing device is used to receive acceleration results from the detection device, and calculate by way of the control program actual values of the sensed accelerations, which is optionally used to control flight of the model airplane.

Other flight information of the model airplane can be obtained with the acceleration data from the detection device. Specifically, the acceleration sensor with three-axis angle can detect the angular acceleration of model airplane in real time, and based on the angular acceleration, the processing device can calculate the rotation angle of the model airplane in the direction of each coordinate axis. The gravity sensor with three-axis can detect the gravity acceleration of model airplane in real time, and the processing device can work out the real-time gravity direction of the model airplane based on gravity acceleration with three-axis. Finally, based on the calculated rotation angle of the model airplane in the direction of each coordinate axis and the real-time gravity direction of the model airplane, the processing device can obtain real-time flight information of the model airplane.

Equally, the handling device transmits the flight information to the control device, and the control device will transmit the control signal to the model airplane based on different flight information and users control condition, so as to automatic control the flight posture of the model airplane in real time, and prevent the model airplane from crashing to ensure the flight safety of the model airplane.

It is preferred that the control device also include a magnetic field sensor in magnetic field direction of magnetic field of the model airplane in a real-time detection.

The control device is also be used to adjust the magnetic field direction, so as to control the flight course of the model airplane and control the flight posture of the model airplane.

The detailed functions of the acceleration sensor with three-axis angle, gravity sensor and magnetic field sensor above can be achieved by a highly-integrated sensor with nine-shaft, or three separate single sensor with three-shaft.

It is preferred that the detection device is set in a central axis line of the fuselage model airplane, preferably near a center of gravity of the model airplane.

It is preferred that the detection device is set in the gravity center position of the model airplane. All gravity centers of the model airplane are set in the central axis line, so setting the detection in the gravity center position can more accurately detect the flight information and flight course data of the model airplane.

Certainly, some deviations from the set position of the above detection device to the above central axis line or gravity center position are feasible, as long as the accuracy and precision in the test can be ensured.

It is preferred that the control device is set on the central axis line of model airplane.

It is preferred that the control device is set in the center of gravity position of the model airplane.

It is preferred that the air pressure sensor is set in the belly of the fuselage of the model airplane.

It is preferred that the air pressure sensor is set on the detection device.

The positive progress effect of the invention lies in: flight information, course data, flight altitude and other flight data of the model airplane can be detected in real time by the invention. Further, the control signal is emitted to control model airplane automatically and adjust flight posture by the invention, and prevent the model airplane crash caused by the improper control of users, thus ensure the flight safety of the model airplane, reduce the difficulty of beginners in practicing the model airplane, and support the wide popularity and promotion of model airplane movement in the public.

Various objects and advantages of the present invention will become apparent from the following description taken in conjunction with the accompanying drawings wherein are set forth, by way of illustration and example, certain embodiments of this invention. The drawings submitted herewith constitute a part of this specification, include exemplary embodiments of the present invention, and illustrate various objects and features thereof.

### BRIEF DESCRIPTION OF THE DRAWINGS

FIG. 1 is a block diagram of the general operation system of the invention model airplane.

### DETAILED DESCRIPTION OF THE INVENTION

Examples of the invention are provided with reference to the FIGURES in the following, and used to explain the technical solutions for the invention in detail

### Example 1

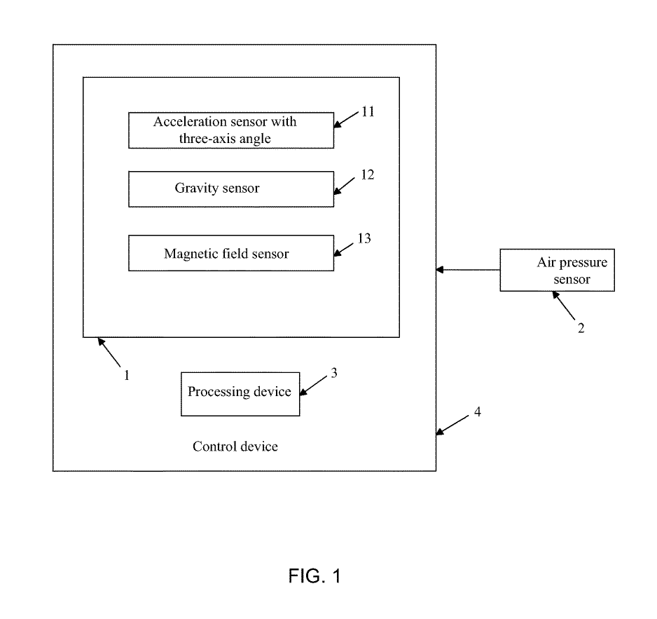

As shown in FIG. 1, the model airplane in this example contains a detection device 1 which is in the gravity center of the model airplane, an air pressure sensor 2 which is on the belly of the model airplane, processing device 3 and control device 4. The detection device 1 is in the gravity center position, which can detect the flight posture, course data and other various flight data for the model airplane more accurately. Thereinto, the detection device 1 includes an acceleration sensor with three-axis angle 11, gravity sensor 12 and magnetic field sensor 13. The acceleration sensor with three-axis angle 11 can detect the angular acceleration of the model airplane in real time, and send angular acceleration to the processing device 3. Further, the processing device 3 can, based on the angular acceleration, work out the rotation angle of the model airplane in the direction of each coordinate axis; the gravity sensor 12 can timely detect gravity acceleration with three-axis of the model airplane, and send the gravity acceleration with three-axis to the processing device 3. Further, the processing device 3 can, based on the gravity acceleration with three-axis, work out the gravity information of the model airplane in real time; the magnetic field sensor 13 can detect the magnetic direction of the model airplane in real time, and transmit magnetic direction to processing device 3; the processing device 3 can, based on the magnetic direction, work out the nose direction of the model airplane. And then the processing device 3 can gain the real-time flight posture and course data of the model airplane by calculation.

Meanwhile, air pressure of the model airplane can be detected with the air pressure sensor 2 in real time, and all air pressure can be transmitted to the processing device 3. Further, the processing device 3 can, based on the air pressure, work out the flight altitude of the model airplane. Specifically, relative flight altitude of the model airplane is calculated through the comparison between the present air pressure and air pressure when the model airplane exactly takes off detected by the air pressure sensor 2.

The control device 4 is used to calculate flight altitude of model airplane by air pressure, compare with an altitude value, and make the model airplane enter a protection mode while the flight altitude is smaller or equal to the altitude value through detection. The purpose of the protection mode is to control the flight posture of the model airplane and make it keep flying.

Then, the processing device 3 will send the calculated flight information, the course data and the flight altitude to the control device 4. The control device 4 transmits the control signal to the model airplane based on the different flight information, different course data and different flight altitudes with the control condition of users, so as to control and adjust automatically the flight posture of the model airplane in real time. Further, it can prevent the model airplane from crashing and ensure the flight safety of the model airplane.

The detailed functions of the acceleration sensor with three-axis angle 11, gravity sensor 12 and magnetic field sensor 13 above can be achieved by a highly-integrated sensor with nine-shaft, or three separate single sensor with three-shaft. Therefore, the detection device 1 can be a sensor with nine-shaft in detailed implementation.

In the example, the control signal can control the control surface of the model airplane, so as to control horizontal takeoff and horizontal landing of the model airplane. Specifically, the detection device 1 uses the acceleration sensor with three-axis angle 11 to detect the angular acceleration of the model airplane in real time when the model airplane takes off. While, the throwing time and direction of model airplane can be obtained through the calculation of angular acceleration by handing device 3. And the flight posture and others of the model airplane can be detected with the detection device 1.

Then, the control signal transmitted the control device 4 can control the relative control surface and power of the model airplane. The model airplane is laid flatly, and the nose can keep certain angles and take off placidly. Equally, it can use the same principle and way to control the horizontal landing when the model airplane is descending. Using the automatic control way can avoid the model airplane crash caused by the misoperation of user s effectively, thus ensure the flight safety of the model airplane.

The detailed functions of the processing device 3 and control device 4 can be offered by a single chip.

But the control related with the flight posture of the model airplane can be prestored in the receiver of the model airplane. Through the communication interface of the receiver, it can be configured and modified by computers, mobile phones and transmitters, etc. The receiver can produce the control signal to control the model airplane to finish the various posture flights after receiving the flight order transmitted by the transmitter.

### Example 2

As shown in FIG. 1, the model airplane in this example contains a detection device 1 which is in the gravity center of model airplane, an air pressure sensor 2 which is in the model airplane belly, the processing device 3 and the control device 4.

The difference between this example and example 1 is: in this example, the control signal transmitted by the control device 4 can be used to make the model airplane fly through maintaining a fixed flight posture. It can be set as the various modes when the model airplane is flying specifically. For example, the model airplane can be set to find the upflow automatically, and then maintain a fixed flight posture to climb step by step; it can be also set to automatically adjust to the initial state of some acrobatic maneuvers when the model airplane is flying in the sky. In this way, users can concentrate on practicing the fixed acrobatic maneuvers to study flight skills of the model airplane deeply.

### Example 3

As shown in FIG. 1, the model airplane in this example also contains a detection device 1 which is in the gravity center of model airplane, a air pressure sensor 2 which is in the model airplane belly, the processing device 3 and the control device 4.

The difference between this example and example 1 is: in this example, the control device 4 can detect the received flight altitude, when the flight altitude of the control device 4 is smaller than or equal to first altitude threshold through detection, the protection mode is used to make the model airplane fly in the first condition; when the flight altitude of the control device 4 is larger than the first altitude threshold, and smaller than the second altitude threshold through detection, the protection mode is used to make the model airplane fly in the second condition; when the flight altitude of the control device 4 is higher than the second altitude threshold through detection, the protection mode is used to make the model airplane fly in the third condition;

The automatic control degree of the model airplane by the control device 4 weakens successively from the first condition, the second condition to the third condition.

Specifically, in the first condition, the control device 4 makes the descent speed of the model airplane be smaller than or equal to the first speed value.

In the second condition, the control device 4 makes the descent speed of the model airplane be smaller than or equal to the second speed value.

The second speed value is larger than the first speed value.

During the detailed implementation of the invention, when the flight altitude of control device 4 is less than or equal to the first altitude threshold through detection, the protection mode is used to make the pitch angle value be larger than or equal to 0 degrees, and the roll angle value be between −20 degrees and +20 degrees, and descent speed be smaller than or equal to 1 m/s. (i.e. the first speed value above). The foregoing is to keep the model airplane fly in the first condition;

Thereinto, when the flight altitude is too slow (i.e. smaller than or equal to the first altitude threshold), there shall be strict control on the model airplane, however, the manual control freedom degree of users will largely be reduced. Keeping the pitch angle be larger than or equal to 0 degrees, that is, being capable of making the model airplane ascent or keep horizontal flight without descent, can avoid plane crash resulted from users make the model airplane descend with remote control. The largest value of the pitch angle is the value under the circumstance that the model airplane can fly normally, which is the general knowledge in this field, so it won't be repeated here. The control devices can achieve the above control procedures through controlling the angular acceleration and gravity acceleration of the model airplane.

When the flight altitude of control device 4 is detected larger than the first altitude threshold, and smaller than or equal to the second altitude threshold, the protection mode is used to make the pitch angle value be larger than or equal to −10 degrees, and the roll angle value be between −45 degrees and 45 degrees, and descent speed be slower than or equal to 3 m/s. (i.e. the second speed value above). The foregoing is to keep the model airplane fly in the second condition;

When the flight altitude of the model airplane is larger than the first altitude threshold, and less than or equal to the second altitude threshold, then users are allowed to control the flight altitude of the model airplane through remote control and make the plane descend, but there are limitations on the descent angle and descent speed values.

When the flight altitude of the control device 4 is detected larger than the first altitude threshold, the protection mode is used to make the pitch angle value be larger than or equal to −30 degrees, and the altitude value be larger than the second altitude threshold.

When the flight altitude of the model airplane is larger than the second altitude threshold, the control freedom degree of the flight posture of the model airplane by users will be largely increased, and the users are allowed to freely control the descent angle and descent speed of the model airplane in relevant larger value scope through remote control. That is, the above keeps the model airplane fly in the third condition.

Preferably, the first altitude threshold is 10 m, and the second altitude threshold is 30 m.

Whereas, the detailed class of flight and relevant control authority can be set in advance, and real-time open or close can be also set during flight.

Though the foregoing describes detailed implementation way of the invention, the technicians in this field shall understand that these are illuminations only.

The technicians in this field can change or modify these implementation ways on the condition that they don't deviate from the principles and essence of the invention, and any change and modification shall be also within the protection scope of the invention.

What is claimed is:

1. A method for controlling a model airplane comprising:
(a) the model airplane comprising a fuselage, an engine, and flight control means comprising wings and control flaps and optionally engine speed;
(b) structural flight control means comprising mechanical sections and connections to control engine speed or variable positions of flight control means to result in taking off, stable flight and landing of the model airplane;
(c) a control device comprising a processing device operating under a control program, where operation of the control program causes structural flight control means to effect flight control changes for the model airplane by changes in the flight control means;
(d) a wireless remote controller is operated by a user to transmit wireless flight control signals received by the processing device to cause the control program to maintain or change flight control means for take off, flight and landing;
(e) periodically sensing of a current altitude of the model airplane by way of an altitude sensor and transmitting the current altitude to the processing device, where the current altitude is compared to a stored control altitude value; and
(f) a protection mode of the control program operates if the current altitude is control signals from causing travel or operation of flight control means to exceed predetermined limits.

2. The method of claim 1 wherein a first control altitude is less than a second control altitude, where the two are values stored in the processing device.

3. The method of claim 2 wherein a first condition of the protection mode operates to restrict maximum travel ranges of flight control means from a ground level to when the current altitude is less than or equal to the first control altitude.

4. The method of claim 3 wherein a second condition of the protection mode operates to restrict maximum travel ranges of flight control means from the current altitude is greater than the first control altitude to when the current altitude is less than or equal to a third control altitude.

5. The method of claim 5 wherein a second condition of the protection mode operates to restrict maximum travel ranges of flight control means from the current altitude is greater than the second control altitude.

6. The method of claim 3 wherein flight control means are restricted in travel so that a pitch angle is greater than 0 degrees.

7. The method of claim 6 wherein flight control means are restricted in travel so that a roll angle is restricted to between −20 degrees to +20 degrees.

8. The method of claim 7 wherein flight control means are restricted in travel so that a descent speed is less than or equal to 1 m/s.

9. The method of claim 4 wherein flight control means are restricted in travel so that in the second condition a pitch angle is greater than −10 degrees.

10. The method of claim 6 wherein flight control means are restricted in travel so that a roll angle is restricted to between −45 degrees to +45 degrees.

11. The method of claim 7 wherein flight control means are restricted in travel so that a descent speed is less than or equal to 3 m/s.

12. The method of claim 5 wherein flight control means are restricted in travel so that in the second condition a pitch angle is greater than −30 degrees.

13. The method of claim 2 wherein the first control altitude is 10 meters.

14. The method of claim 4 wherein the second control altitude is 30 meters.

15. The method of claim 1 wherein the control device comprises a detection device that detects three-axis angle of angular acceleration and transmits it to the processing device for calculation of real time calculation of angular acceleration of the model airplane, which thereafter results in reduction, maintenance or increase in the angular acceleration of the model airplane to maintain it in a predetermined range of angular acceleration.

16. The method of claim 1 wherein the control device comprises a detection device that detects three-axis angle of gravity acceleration and transmits it to the processing device for calculation of real time calculation of gravity acceleration of the model airplane, which thereafter results in reduction, maintenance or increase in the gravity acceleration of the model airplane to maintain it in a predetermined range of gravity acceleration.

17. The method of claim 1 wherein the control device comprises a magnetic field sensor for detecting a magnetic field direction of the model airplane and transmitting it to the processing device for calculation of real time magnetic direction of travel of the model airplane, which thereafter results in maintenance of or correction in course of the model airplane to maintain it in a predetermined range of magnetic directions.
